(19) United States
(12) Patent Application Publication
(10) Pub. No.: US 2006/0022784 A1
(43) Pub. Date: Feb. 2, 2006

(54) Microtechnological device comprising magnetically assembled structures and assembly process

(76) Inventor: Christophe Kopp, Le Fomtamit- Corn.Tlom (FR)

Correspondence Address: Robert E. Krebs;Thelen Reid & Priest LLP, P.O. Box 640640, San Jose, CA, 95164-0640, US

(21) Appl. No.: 11/190,706

(22) Filed: Jul. 26, 2005

(30) Foreign Application Priority Data
Jul. 28, 2004 (FR) 04 51688

(51) Int. Cl. H01F 27/00

(52) U.S. Cl. 336/100

(57) ABSTRACT

A process for assembly of different elements making up a microtechnological device is described. The assembly process comprises attachment of the two elements together by magnetic interaction of means that are made in the elements. Preferably, assembly and attachment are followed by an alignment of the elements due to magnetic interaction between the means. Alignment may be passive or dynamic, due particularly to the presence of a matrix of electromagnets in at least one of the means.

### TECHNICAL FIELD

The invention relates to the assembly and attachment of miniature devices, derived particularly from microtechnology. One particular application of the invention is the alignment of different optical, electrical, mechanical and optoelectronic components.

### STATE OF PRIOR ART

The different constituents of a device are usually assembled on a support or a substrate using mechanical clamping, bonding or soldering techniques. There are several disadvantages with the application of these three processes to miniature optical, electronic or mechanical components derived from microtechnology.

For example, bond is a widely applied technique particularly using photo cross-linkable glues, since this technique makes it possible to align components before they are fixed. However, this process can reduce the reliability of components due to the addition of an exogenic compound: for example, degassing of glue, and particularly of an epoxy type resin, close to a laser diode is critical due to the condensation that can be deposited on the emitting surface of the optical source.

Soldering is also extensively applied; in particular, it enables self-alignment of components due to the <<flip-chip >> technique: meltable balls are located on matrices of metallised areas and are heated. The surface tension of the melting balls causes superposition of the matrices of metallised areas on the component and on its support. On the other hand, soldering requires the use of liquid or gas flows that can also reduce the reliability of components. Furthermore, the device has to be heated to above 100° C. for soldering, which can also deteriorate some components.

Mechanical clamping does not change the nature of the microtechnological components. However, it does require that additional voluminous components should be inserted which increase the support area of the device. But this insertion is not always possible, particularly when different components have to be placed close to each other. Furthermore, it is impossible to precisely respect a prior alignment with this type of assembly.

Document U5 6,049,947 proposes an adapted tooling containing magnets to facilitate alignment. However, this structure is long and expensive to implement.

### PRESENTATION OF THE INVENTION

Therefore, the invention is intended to find a process that can be used to assemble, align (or self-align) and fix miniature components derived from microtechnology without the disadvantages of known techniques.

According to one of its aspects, the invention relates to a microtechnological device comprising several assembled elements fixed to each other by magnetic interaction of means or structures included with them. Due to this attachment choice, it is possible to align elements with each other without modifying their properties during fixing.

Elements may include different components known in microtechnology, and particularly one of the elements may be a substrate that is fixed to a component wafer or to one or several different components.

It is also possible to fix the different components to each other. “Component” means lenses, laser chips, emitters, mechanical components such as optical fibre or optoelectronic supports, for example.

Magnetic interaction means may include magnetisable materials, magnetised alloys or electromagnets. They may be structures located at the surface of the elements that they fix, for example by deposition or by transfer of individual compounds. The means for magnetic interaction may have the same or a complementary nature, in terms of the shape and the nature of their constituents, or their general geometry.

The means preferably comprise matrices of several compounds that can generate a magnetic field so as to enable a precise alignment. It is possible that the matrices could be superposed; according to another embodiment, a structure also comprises a second matrix of electromagnets so as to enable dynamic alignment.

The invention also relates to a process for assembly by magnetic interaction of the elements of a microtechnological device. The assembly is preferably accompanied by a passive or dynamic alignment of the elements.

Advantageously, the magnetic interaction assembly step is preceded by a step to form magnetisable or magnetised means on the elements. Magnetic means may be formed by the deposition of layers of magnetised alloys or electromagnets, or by the transfer of individual compounds.

### BRIEF DESCRIPTION OF THE DRAWINGS

The attached Figures will help to give a better understanding of the invention, but they are only given for information and are in no way restrictive.

FIGS. 1A, 1B, 1C and 1D show devices according to the invention, the two elements being separated.

FIG. 2 shows a configuration of magnetic means for a device according to an embodiment of the invention enabling dynamic alignment.

FIG. 3 shows another embodiment of a device according to the invention.

### DETAILED PRESENTATION OF PARTICULAR EMBODIMENTS

The invention proposes to align and fix the components to be assembled, for example on a support, due to magnetic interaction between magnetisable means included in each of the elements to be assembled.

With some techniques, it is possible to integrate with elements to be assembled means capable of generating a sufficiently powerful magnetic field to fix these elements. The size of the structures thus created remains compatible with microtechnology.

Thus, according to one preferred embodiment of the invention, a magnetised or magnetisable area or an area comprising electromagnets is made on a substrate or on any other electronic or optical or optoelectronic or micromechanical component or any other component conventionally used in microtechnology, preferably on the surface so as to improve the alignment. This may be done by transferring individual compounds or by deposition of a layer of material and a lithographic machining technique, for example etching, on a substrate:

1) For example, unit compounds are machined in samarium-cobalt or aluminium-nickel-cobalt or neodymium-iron-boron type metallic alloys: these metals are said to be magnetic since they remain strongly magnetised once they have been subjected to a magnetic field. Compounds are manufactured in an appropriate shape (disks, square wafers, elongated strips, etc.) and are then positioned on the element to be fixed, if possible with a uniform geometry. They are fixed (to them) using conventional techniques, for example by bonding, molecular bonding, thermocompression, soldering, laser welding or electron beam welding.

2) For example, individual electromagnets are made by winding a very thin copper wire (typical diameter of the order of 50 μm). These compounds may be transferred onto a substrate such as a printed circuit or a metallised ceramic circuit, to connect electromagnets to the control system through electrical tracks. The same placement system can be set up as in example 1 above.

3) Cobalt-platinum or cobalt-platinum-phosphorus or nickel-iron magnetic materials can also be set up directly on the element to be fixed by electrolytic deposition or vapour phase plasma deposition (PVD). The magnetised areas thus produced may be structured geometrically by lithographic techniques derived from microelectronics, for example by etching. This type of process is capable of generating thicknesses of several micrometers.

4) It is also possible to deposit resins containing powdered magnetic materials on a surface of a microtechnological component, so as to make patterns several tens of micrometers thick (for example see Cho H J and Ahn C H: <<Microscale resin-bonded permanent magnets for magnetic micro-electro-mechanical systems applications >>, Journal of Applied Physics 2003; 93(10): 8674-76).

5) A deposition of a multilayered electromagnets may be made by a lithographic technique so as to obtain a shape similar to a coil with a material such as copper. In this configuration, the electrical tracks connecting the electromagnets to the control system are usually made on the substrate using the same techniques.

6) Other processes could be considered to increase the thickness of <<micro magnets >> if this is preferred. For example, a deposition of Nd—Fe—B by a pulsed laser can result in thicknesses of the order of 40 to 50 μm (Nakano M and al.: <<Fabrication of Nd—Fe—B thick film magnets by high speed PLD method >>, IEEE Transaction on Magnetics 2003; 39(5): 2863-65).

These different production processes can be used to obtain small areas that can create magnetic fields, but for which the power is sufficient to keep a microtechnological component in place. More particularly, magnets obtained using the transfer technique (1 and 2) may conventionally have an area of the order of 1 mm² for a height of 0.5 mm, and can easily be put into place at a pitch of the order of 1 mm. For microelectronic technologies, magnets with a surface area of less than 0.5×0.5 mm² are possible for a height of 5 to 50 μm with a pitch of 100 μm, for example.

For example, a CoPt electrolytic deposition can be used to make a 5 μm thick magnet with an area of approximately 100 μm generating a force of a few N, or several mg/mm². Such a force is sufficient for miniature components: typically, a 0.5 mm thick piece of silicon with an area of 1 mm² weighs about 1 mg.

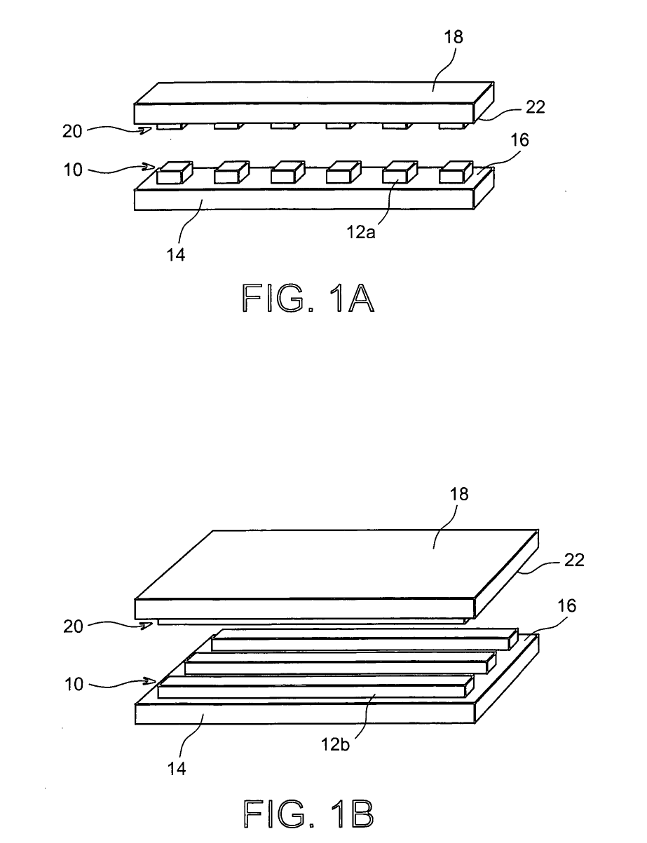

Preferably, the areas thus created form magnetic means or structures in the form of matrices, as shown diagrammatically in FIG. 1. In particular, the matrices 10 may be composed of a strip of square magnets 12a (FIG. 1A), or an alignment of parallel strips 12b passing through the support 14 (FIG. 1B) or a regular mesh by round magnets 12c on the surface 16 of an element 14 to be fixed (FIG. 1C). The magnets may be on the surface or they may be <<buried >> as in FIG. 1D, in other words the magnets 12d may be embedded in the support 14, with their surface flush with the surface 16 of the support.

Preferably, when a component 18 is designed to be fixed on a substrate 14, the magnetic means 10, 20 of each component may be composed of superposable inversely polarised matrices so as to attract each other, as shown diagrammatically in FIGS. 1A and 1B.

During assembly of the two elements 14, 18 and after a very approximate adjustment so as to approximately superpose the matrices 10, 20, the surfaces 16, 22 to be brought into contact are sufficiently close to enable the generated magnetic forces to more precisely position the matrices 10, 20 and thus to self-align the component 18 on the substrate 14. Thus, the adjustment may be better than 1 μm. The surfaces 16, 22 are then brought into contact to maximise magnetic attraction forces and thus keep the component 18 in place and maintain the alignment.

It is obvious that the thicknesses of the magnets in the Figures are not to scale. Furthermore, depending on the application, elements will be in relief over the surface of the element or they may be buried (FIG. 1D) to be flush with the surface 16 so that the clearance between the elements 14, 18 can be adjusted.

The geometry of the magnetic compounds 12 of the matrices 10, 20 may be identical, but it may also be slightly different depending on size constraints on the faces to be assembled: for example see FIG. 1C. Thus, a matrix 10 of round magnets 12c can be superposed on a matrix 20 of square magnets 12a. It is also possible to choose complementary geometries so as to improve the self-alignment capacity, for example using an annular magnet on one of the components.

Obviously in these examples, the term <<magnetic compound >> covers firstly the magnets, but also the different possibilities described above. In particular, one or both matrices 10, 20 may be partially or entirely composed of electromagnets, so that magnetic attraction forces can be activated under electrical control.

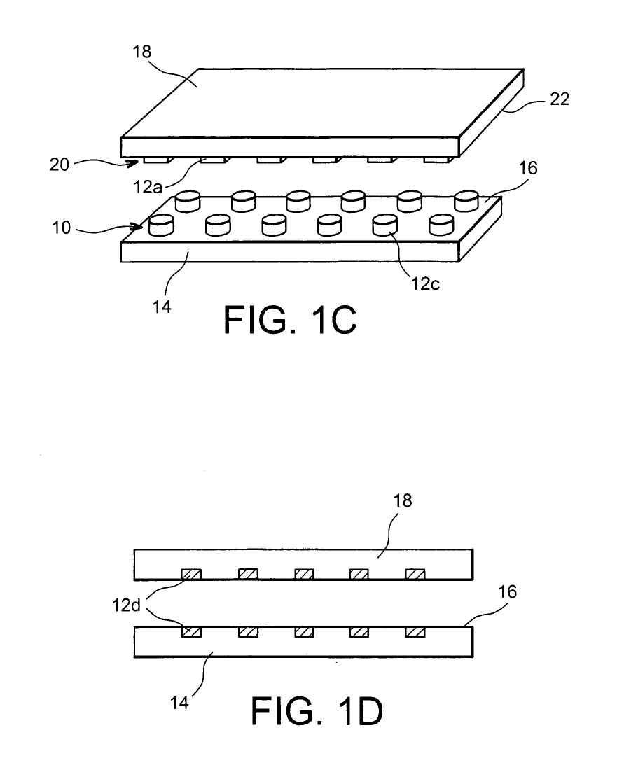

The device 30 shown in FIG. 2 forms one particular example of this type of configuration. A component 32, advantageously in the form of a wafer, for example the substrate, comprises a first matrix of electromagnets 34. An offset matrix 36 is provided on the surface 38 to be brought into contact. This can be used to make a dynamic electrically controlled alignment during or after deposition of the component 40 on the substrate 32 by activating one or the other matrices 34, 36 of electromagnets. Thus, the position of the component 40 on the substrate 32 may be corrected during or after deposition.

FIG. 2 also shows the additional but unnecessary presence of two sets of magnets 42, 44 on the component 40: it is possible to vary one of the two elements 32, 40 to be fixed, or to provide two different alignment possibilities.

For this type of a dynamic alignment, it is also possible to combine the natures of the magnetic means and to make a hybrid passive and active alignment system to enable fine positioning corrections, for example by replacing one of the matrices of electromagnets 34, 36 or 42, 44 by a matrix of magnetised compounds.

The positioning and assembly techniques described may be applied to any sort of component; optical components such as microlaser chips, lenses, emitters or mechanical components such as optical fibre supports may be associated with the substrate or with each other or even optoelectronic components with detector matrices.

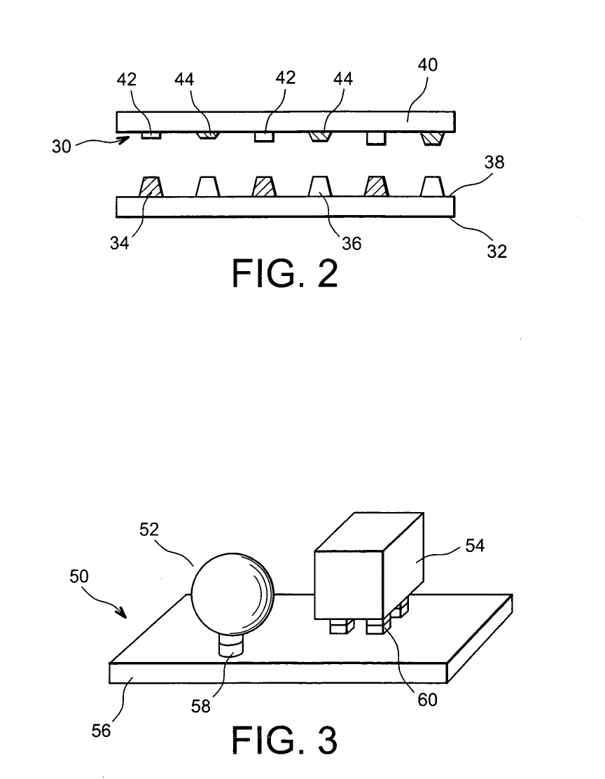

By combining the geometry of magnets, it is also possible to assemble compounds with different natures on the same support: see device 50 in FIG. 3 that presents the assembly of a lens 52 and a laser chip 54 on the same substrate 56 using magnetised means with different matrices 58, 60.

For example, the following compounds could be fixed by the process according to the invention: spherical microlens with diameter 500 μm, 1 mm³ microlaser chip, 1 mm wide micro-mirrors and micro-prisms, 1 mm×200 μm diode type laser source, 0.5 mm² VECSEL type laser source, etc. Similarly, it was possible to position a 500 μm thick component wafer (particularly of the silicon substrate type used in microelectronics) with a side length of 1 to 30 cm in a fixed manner. Magnet matrices with pitches of 100 μm to 1 mm can be used for these different productions.

The alignment and assembly process according to the invention has several advantages including the following:

attachment of components by magnetic forces, unlike bonding and soldering, does not require any application of a liquid or gas flow, or heating, and does not introduce any risk of degassing that could reduce the reliability of components;

it is possible to self-align the component on the support, like a magnetic <<flip-chip >>;

magnetic forces may be activated on request and with delay, by electrical control;

the component can be dynamically aligned on the support and the component position on the support can be corrected;

thermal and electrical conduction within the microtechnological device are improved due to metal/metal contact by means that can produce a magnetic field;

several components can be positioned precisely and fixed on the same substrate.

1. Microtechnological device comprising at least two elements, each of the elements comprising means of producing a magnetic field wherein the elements are directly fixed together by magnetic interaction between their means.

2. Device according to claim 1 wherein means of at least one element are located at the surface of this element which is in contact with another element to which it is fixed.

3. Device according to claim 2 wherein each of the means is located on a surface of the corresponding element which is in contact with another element to which it is fixed.

4. Device according to of claim 1 wherein the means of producing a magnetic field comprise at least one magnetisable material.

5. Device according to claim 4 wherein the magnetisable material is a samarium-cobalt, aluminium-nickel-cobalt, neodymium-iron-boron, cobalt-platinum-phosphorus, cobalt-platinum or nickel-iron type magnetic metallic alloy.

6. Device according to claim 1 wherein the means of producing a magnetic field comprise an electromagnet.

7. Device according to claim 1 wherein a first element comprises first means comprising a first matrix of compounds that can produce a magnetic field.

8. Device according to claim 7 wherein a second element comprises second means comprising a second matrix of compounds that can produce a magnetic field.

9. Device according to claim 8 wherein the first matrix and the second matrix are superposable.

10. Device according to claim 8 wherein the second means comprise a third matrix.

11. Device according to claim 1 wherein an element comprises a substrate wafer.

12. Device according to claim 11 wherein an element fixed to the substrate wafer comprises a plurality of different microtechnological components.

13. Device according to claim 11 wherein an element fixed to the substrate wafer comprises a microtechnological component wafer superposable on the first element.

14. Assembly process for a microtechnological device comprising two elements, wherein means of producing a magnetic field are made in each element, and the two elements are assembled by magnetic interaction between the means.

15. Assembly process according to claim 14 wherein an element has a plane surface and the means are made by deposition of magnetic material.

16. Assembly process according to claim 14 wherein an element has a plane surface and the means are made by deposition of an electromagnet multilayer.

17. Assembly process according to claim 14 wherein the means are made by transfer of magnetic components and/or electromagnets on the element.

18. Assembly process according to claim 14 wherein the first means of a first element comprise a first matrix of compounds and the second means of a second element comprise a second matrix of compounds, the first and second matrices being superposable.

19. Assembly process according to claim 18 wherein the first means comprise a third matrix of compounds superposable on the second matrix.

20. Assembly process according to claim 18 also comprising the alignment of the two elements by interaction of the first matrix with the second matrix.

21. Assembly process according to claim 19 wherein the compounds of one of the first and third matrices are electromagnets and comprising a dynamic alignment of the elements by control of electromagnets.

22. Microtechnological device comprising:
a first element comprising a first matrix of compounds chosen from magnetisable materials and electromagnets,
a second element comprising a second matrix of compounds chosen from magnetisable materials and electromagnets,
wherein the first and second elements are directly fixed together by magnetic interaction between the first and second matrices.

23. Device according to claim 22 wherein the second element comprises a third matrix of electromagnets offset to the second matrix and superposable to the first matrix.
